(19) United States
(12) Patent Application Publication
(10) Pub. No.: US 2026/0084577 A1
(43) Pub. Date: Mar. 26, 2026

(54) SYSTEMS AND METHODS FOR SCORING ELECTRIC VEHICLE CHARGERS

(71) Applicant: Ford Global Technologies, LLC, Dearborn, MI (US)

(72) Inventors: Su Yu, Royal Oak, MI (US); Kai Wu, PITTSBURGH, PA (US); Chen Zhang, South Lyon, MI (US)

(73) Assignee: Ford Global Technologies, LLC, Dearborn, MI (US)

(21) Appl. No.: 18/891,091

(22) Filed: Sep. 20, 2024

(51) Int. Cl. B60L 53/68; B60L 53/66

(52) U.S. Cl. CPC B60L 53/68; B60L 53/66; B60L 2240/70

(57) ABSTRACT

A charger scoring system including a transceiver and a processor is disclosed. The transceiver may be configured to receive a vehicle information from a vehicle. The vehicle information may include a vehicle charging information and a vehicle geolocation information. The transceiver may be further configured to receive a charger information associated with a charger located at a charging station, and a charging station geolocation. The processor may be configured to determine a charging event by correlating the vehicle geolocation information and the charging station geolocation. The processor may further correlate the charger information with the vehicle charging information, responsive to determining the charging event. The processor may additionally estimate a charger reliability score associated with a charger based on the correlation between the charger information and the vehicle charging information. The processor may further transmit the charger reliability score to an external device.

### FIELD

The present disclosure relates to systems and methods for calculating reliability scores for electric vehicle (EV) chargers based on connected vehicle data and dynamic charger history.

### BACKGROUND

Electric Vehicles (EVs) require regular charging at EV charging stations to ensure optimal vehicle operation. As the EV adoption increases, the number of EVs has increased considerably, resulting in a surge of demand for charging solutions/stations.

EV users typically prefer to charge at those charging stations that provide reliable charging experience. Therefore, many-a-times, the users rely on charging station ratings/scores and/or reviews to select an optimal charging station at which the vehicles may be charged. It is known that in many instances, even the charging stations with high ratings/scores may have one or more chargers/Electric Vehicle Supply Equipment (EVSE) that may be malfunctioning or in suboptimal condition. Such instances cause inconvenience to the users if they attempt to plug-in their vehicles to these malfunctioning chargers.

Thus, a system and method is required that facilitates a user to conveniently determine a reliability of a charger at a charging station.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a schematic diagram of a process to calculate a charger reliability score in accordance with the present disclosure.

FIG. 3 depicts an example view of a comparison between charging timestamps of a vehicle and a charger in accordance with the present disclosure.

FIG. 4 depicts a flow diagram of an example first method to estimate a charger reliability score in accordance with the present disclosure.

FIG. 5 depicts a flow diagram of an example second method to estimate a charger reliability score in accordance with the present disclosure.

### DETAILED DESCRIPTION

### Overview

The present disclosure describes a charger scoring system (“system”) that may be configured to determine reliability scores associated with one or more chargers or Electric Vehicle Supply Equipment (EVSE) located at a charging station.

It may be appreciated that typically reliability scores/ratings are available at charging station level, and not at EVSE level. Therefore, a user arriving at a charging station may not know which EVSE within the charging station provides better charging experience than the others. To facilitate the users in knowing which EVSE provides a better charging experience, the system determines reliability scores at EVSE level, and transmits the scores to the user devices so that the users may make an informed decision of choosing an optimal EVSE to charge their vehicles. The EVSE reliability scores also facilitate charging station operators to determine the EVSE(s) that may need repair or replacement (e.g., those EVSEs that have low reliability scores).

The system may be configured to receive vehicle information from a plurality of vehicles, and charging station information from computing devices associated with a plurality of charging stations. The vehicle information may include vehicle identifier (ID), location/GPS information, Media Access Control (MAC) addresses of chargers that the vehicle used for charging over a predefined historical time duration (e.g., 90 days), and/or the like. The charging station information may include charging station geolocation information, a data structure including a mapping of a plurality of chargers with a plurality of MAC addresses, dynamic charger history data or charger information, and/or the like.

Responsive to receiving the information described above, the system may first group individual charging sessions into distinct charging events or “EVSE visits” by each vehicle to EVSEs. The system may further match these EVSE visits to the charging stations by correlating the vehicle's GPS information with the charging station's geolocation information. The system may then match the EVSE visits to distinct EVSEs within the charging stations by correlating the MAC address information included in the vehicle information and the mapping of the plurality of chargers with the plurality of MAC addresses. The system may additionally match the EVSE visits to distinct EVSEs by correlating vehicle's charging timestamp information included in the vehicle information and charger's charging timestamp information included in the dynamic charger history data.

The system may then score each EVSE visit based on a plurality of parameters including, but not limited to, a change in vehicle's state of charge (SOC) during the EVSE visit, a count of charging faults encountered by the vehicle during the EVSE visit (determined based on the vehicle information), a count of instances where no charge was delivered to the vehicle during the EVSE visit (determined based on the vehicle information), and/or the like. Responsive to scoring each EVSE visit, the system may aggregate the EVSE visit scores to EVSEs, thereby calculating the reliability score for each EVSE.

The system may be further configured to evaluate a confidence level associated with the calculated EVSE scores based on a plurality of parameters including, but not limited to, recency of last visit to the EVSE, visits per EVSE, unique vehicle IDs per EVSE, and/or the like. Responsive to evaluating the confidence level, the system may enhance the EVSE scores with low confidence level by using one or more Machine Learning (ML) techniques, and by using the dynamic charger history data or charger information.

The system may be additionally configured to transmit the determined EVSE scores and the associated confidence levels to the user devices of the vehicle users, and/or to the computing devices associated with the charging station operators to aid their decision making process.

The present disclosure discloses a charger scoring system that determines reliability scores for individual chargers/EVSEs at a charging station. The EVSE scores assist the vehicle users in easily identifying which chargers are better than the others at a charging station, and hence facilitates the users in selecting the best available chargers for vehicle charging. The EVSE scores also assist the charging station operators to conveniently identify those chargers that may need repair/replacement (e.g., those chargers that have low reliability scores).

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

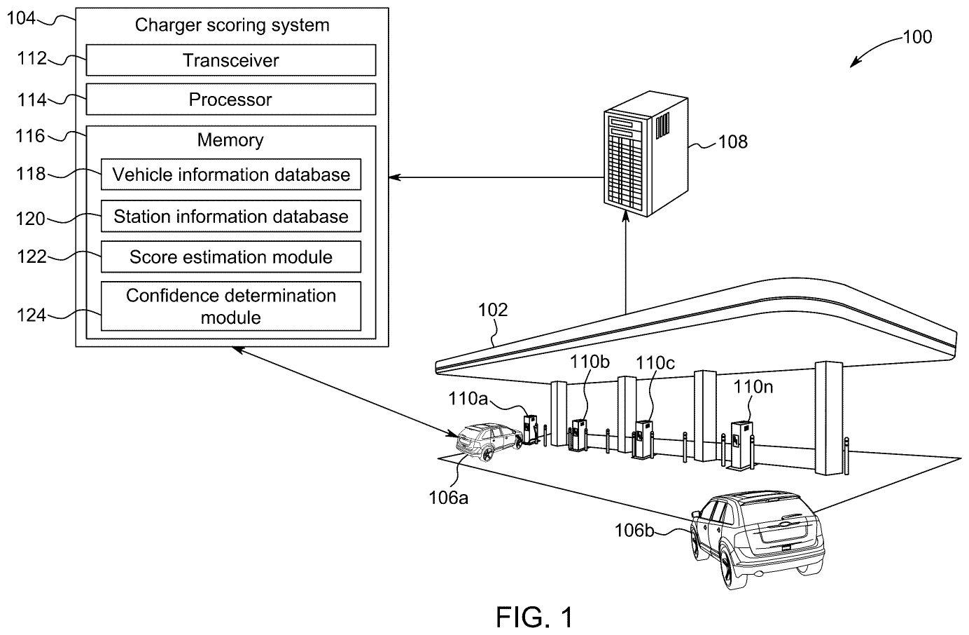

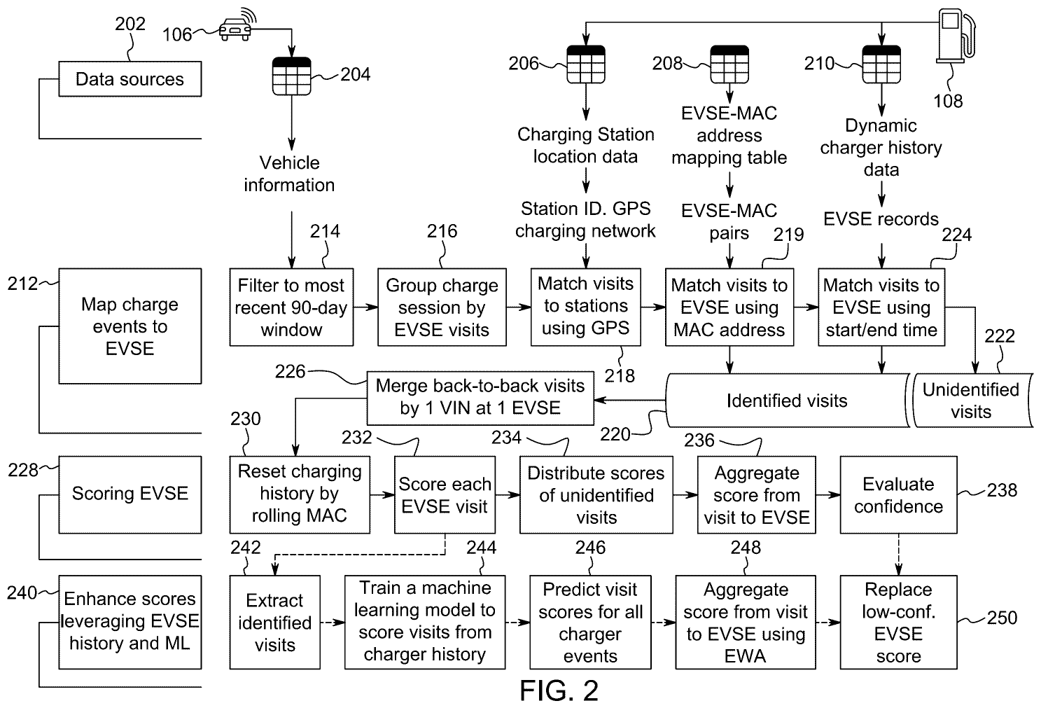

FIG. 1 depicts an environment 100 in which techniques and structures for providing the systems and methods disclosed herein may be implemented. While describing FIG. 1, references will be made to FIGS. 2, 3 and 4.

The environment 100 may include a charging station 102, a charger scoring system 104 (or system 104), and a plurality of vehicles including a vehicle 106a, a vehicle 106b, etc. (collectively referred to as plurality of vehicles 106). The system 104 may be communicatively coupled with the charging station 102 via a charging station computing device or a server 108, and the plurality of vehicles via one or more networks. The network(s), as described herein, illustrates an example communication infrastructure in which the connected devices discussed in various embodiments of this disclosure may communicate. The network may be and/or include the Internet, a private network, public network or other configuration that operates using any one or more known communication protocols such as transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In some aspects, each vehicle 106 may take the form of any passenger or commercial vehicle such as a car, a work vehicle, a crossover vehicle, a truck, a van, a minivan, a taxi, a bus, etc. Each vehicle 106 may be a manually driven vehicle or may be configured to operate in a partially/fully autonomous mode. In an exemplary aspect, each vehicle 106 may be an Electric Vehicle (EV) or a hybrid vehicle. The vehicles 106 may be configured to get charged at the charging station 102 (and other similar charging stations).

In an exemplary aspect, the charging station 102 may be a public charging station, and may include a plurality of Electric Vehicle Supply Equipment (EVSE) or chargers 110a, 110b, 110c, 110n (collectively referred to as chargers 110). The vehicles 106 may be configured to charge at the charging station 102 via the chargers 110.

The system 104 may be communicatively coupled with a plurality of charging stations (via their respective computing devices, e.g., the device 108 and the network described above) and a plurality of vehicles (including the vehicles 106) that may get charged at the charging stations. The system 104 may be configured to estimate/calculate reliability scores or ratings of the chargers (e.g., the chargers 110) included in each of the plurality of charging stations (e.g., the charging station 102). It may be appreciated that conventionally reliability scores or ratings are estimated/calculated at a charging station level, and not at a charger level. Therefore, a user may determine whether a specific charging station has a high or a low reliability score; however, by using the charging station reliability score, the user may not be able to determine which charger within the charging station provides better charging experience than the other chargers. The system 104 facilitates the users by determining and transmitting (e.g., to user devices) a reliability score for each charger at the charging stations, thereby enabling the users to select an optimal charger to charge their respective vehicles.

The system 104 may be hosted on a server/cloud, and may include a plurality of components including, but not limited to, a transceiver 112, a processor 114 and a memory 116. The transceiver 112 may be configured to transmit/receive information or data to/from external devices, e.g., the server 108, the vehicles 106, the user devices (not shown) associated with vehicle users, and/or the like, via the network described above.

The processor 114 may be in communication with one or more memory devices in communication with the respective computing systems (e.g., the memory 116 and/or one or more external databases not shown in FIG. 1). The processor 114 may utilize the memory 116 to store programs in code and/or to store data for performing aspects in accordance with the disclosure. The memory 116 may be a non-transitory computer-readable storage medium or memory storing a program code that enables the processor 114 to perform operations in accordance with the present disclosure. The memory 116 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 116 may include a plurality of databases and modules including, but not limited to, a vehicle information database 118, a station information database 120, a score estimation module 122, and a confidence determination module 124. The score estimation module 122 and the confidence determination module 124 may be stored in the form of computer-executable instructions, and the processor 114 may be configured and/or programmed to execute the stored computer-executable instructions for performing functions/operations in accordance with the present disclosure. The functions of the memory databases and modules are described later in the description below.

In operation, the transceiver 112 may receive information from a plurality of data sources 202 via the network described above. For example, the transceiver 112 may receive historical vehicle information 204 (as shown in FIG. 2) from the plurality of vehicles 106 for a past predefined time duration (e.g., past 90, 180, 360 days, or the like). In an exemplary aspect, the vehicle information 204 may include a vehicle identifier (ID), a vehicle geolocation information (e.g., GPS location information), a vehicle charging information including timestamp information associated with vehicle's plug-in/plug-out to various chargers (e.g., the chargers 110) over the past predefined time duration, EVSE/charger's MAC address at which the vehicles 106 may have charged over the past predefined time duration, a change in vehicle's state of charge (SOC) during each vehicle charging instance, and/or the like. The transceiver 112 may transmit the received vehicle information 204 to the vehicle information database 118, which may be configured to store such information for all vehicles 106.

The transceiver 112 may further receive charging station information associated with the plurality of charging stations (including the charging station 102) from the server 108 (and other similar computing devices/servers). The charging station information may include, for example, a charging station location data or geolocation, a charging station ID, etc. (shown as a block 206 in FIG. 2), a data structure comprising a mapping between the plurality of chargers 110 at the charging station 102 and a plurality of MAC addresses (shown as a block 208 in FIG. 2), and a charger information associated with each charger 110 located at the charging station 102 or “dynamic charger history data” for the past predefined time duration (shown as a block 210 in FIG. 2). The charger information may include a plurality of information associated with the charger 110, for example, timestamps when the charger 110 charged vehicles (e.g., the vehicles 106 or other vehicles) over the past predefined time duration, charge status information (e.g., the time durations when the charger 110 was charging, available, out-of-order, etc.), charger ID, and/or the like.

The data structure described above may include information associated with charging station ID, EVSE or charger ID, charger's mapping (or charger ID's mapping) to MAC addresses, effective first and last dates of the MAC address if the MAC address is updated (which indicates a hardware update), and/or the like.

The transceiver 112 may transmit the received charging station information to the station information database 120, which may be configured to store such information for all charging stations.

Responsive to the transceiver 112 receiving the vehicle information 204 and the charging station information described above, the processor 114 may obtain such information from the respective databases or directly from the transceiver 112, to commence a process to map vehicle charge events with EVSE or specific chargers (shown by a block 212 in FIG. 2). Specifically, the processor 114 commences the process of mapping vehicle charge records (as identified from the vehicle information 204) with one or more chargers 110, responsive to obtaining the vehicle information 204 and the charging station information.

To perform the mapping process, the processor 114 may first filter the vehicle information 204 and the charging station information to the most recent 90-day window (or any other window, e.g., 120-day window, 180-day window, or the like), as shown by a block 214. Thereafter, based on the vehicle information 204, the processor 114 may group “charge sessions” by vehicle charge visits/EVSE visits or charging events, as shown by a block 216. In the present disclosure, a charge session is defined as a charging record in the vehicle information 204 (specifically vehicle charging information) that includes a set of plug-in timestamp and a plug-out timestamp. A charge session may be considered as a smallest unit of a charge record in the vehicle charging information.

A person ordinarily skilled in the art may appreciate that a charge session, which may be available in the vehicle information 204, may or may not be available in the dynamic charger history data or the charger information, because many charge sessions that are unsuccessful at an early stage (before communication with an EVSE is established) do not have a MAC address and hence may not be available in the dynamic charger history data. However, it may be appreciated often EV drivers who encounter unsuccessful charging at a first time do not give up immediately. They tend to attempt charging at the same EVSE a few more times before driving the vehicle away. With this logic, the processor 114 defines an EVSE visit or a charging event or a charge visit to an EVSE/charger by “grouping” charging sessions or charge sessions in the vehicle information 204 that may have the same vehicle identification number (VIN) or vehicle ID, odometer reading within a predefined odometer threshold (e.g., 0.1 m to 1 km), vehicle GPS reading within a predefined GPS threshold (e.g., 0.1 m), and/or indications of no or minimal vehicle movement based on vehicle in-motion signals/alerts (all of this may be part of or can be deduced from the vehicle information 204).

In this manner, the processor 114 maps each charging session to one EVSE visit (and not more than one EVSE visit). Once the processor 114 finishes with grouping the charging sessions to distinct EVSE visits, the output may be a list of EVSE visits undertaken by each vehicle 106 over the recent 90-day window.

Responsive to grouping the charging sessions to distinct EVSE visits, the processor 114 may match each EVSE visit with a charging station by using GPS information, as shown by a block 218. In this case, the processor 114 may correlate the vehicle geolocation information (included in the vehicle information 204) and the charging station geolocation (included in the charging station information), and determine which EVSE visit is associated with which charging station based on the correlation. For example, based on the correlation, the processor 114 may determine that an EVSE visit for the vehicle 106a is associated with the charging station 102, when the vehicle 106a geolocation during the EVSE visit matches with the charging station 102 geolocation.

In some aspects, an EVSE visit (e.g., an EVSE visit associated with the vehicle 106a) may be mapped to a charging station (e.g., the charging station 102) when a geo-distance between the vehicle 106a during the EVSE visit and the charging station 102 geolocation is less than a predefined distance threshold (which may be set or defined by a system operator). If multiple charging stations are found within the predefined distance threshold, then the processor 114 maps the charging station that may be closest to the vehicle 106a, to the EVSE visit.

In this manner, all EVSE visits associated with the plurality of vehicles 106 are mapped to the plurality of charging stations. In some aspects, one EVSE visit is mapped to just one charging station, and one EVSE visit cannot be mapped to multiple charging stations.

Responsive to mapping the EVSE visits with the charging stations, the processor 114 may commence a process to map each EVSE visit to a charger within the mapped charging station. For example, if an EVSE visit of the vehicle 106a is mapped to the charging station 102, the processor 114 may commence the process to map the EVSE visit to the specific charger 110 at which the vehicle 106a may have charged (or may have attempted to charge).

The processor 114 may perform one or more steps sequentially or in parallel to map EVSE visits to EVSE/chargers. In some aspects, to perform these steps, the processor 114 may correlate the vehicle information 204 and the charging station information (specifically the charger information or the dynamic charger history data), as described below.

In an exemplary aspect, the processor 114 may first match each EVSE visit to a charger by using MAC address information that may be included in the vehicle information 204 (or the vehicle charging information) and the charger information, shown by a block 219 in FIG. 2. It may be appreciated that a vehicle receives the EVSE MAC address as part of the vehicle-EVSE communication for each charge session (that may be included in the vehicle information 204). The processor 114 may use the mapping between the plurality of chargers 110 and the plurality of MAC addresses to map each charging session with an EVSE/charger, and then aggregate the charging sessions to EVSE visits, as described above.

As an example, if the vehicle information 204 indicates that a charging session (or an EVSE visit, if the EVSE visit includes a single charging session) is associated with a MAC address 1 (or a first MAC address), the processor 114 may correlate the MAC address 1 with the mapping, to identify the EVSE or charger that may have the same MAC address. Thereafter, the processor 114 may map the EVSE visit to the identifier EVSE. For example, if the charger 110a is associated with a MAC address 2 (or a second MAC address), and the processor 114 determines that the second MAC address is equivalent to the first MAC address by correlating the first MAC address with the mapping, the processor 114 may determine that the EVSE visit may be associated with the charger 110a and then map the EVSE visit with the charger 110a. In this manner, the processor 114 maps an EVSE visit to a charger/EVSE.

In some aspects, mapping via the MAC address information is the first step performed by the processor 114 before executing other mapping techniques, because it is considered the most reliable approach. All identified or “mapped” EVSE visits (i.e., the EVSE visits that are mapped to chargers/EVSE by using the MAC address information) are recorded in the memory 116. It may be appreciated that this step does not guarantee mapping of all EVSE visits. For example, this approach requires the charging station computing devices (e.g., the server 108) not to randomize EVSE MAC addresses. For the charging station computing devices that do randomize the MAC addresses, this step is skipped and no EVSE visits are mapped by using the MAC address information. In other cases (or in the charging sessions) when the communication module between the vehicle and the EVSE malfunctions and the EVSE MAC address signal cannot be transferred to the vehicle (and hence not included in the vehicle information 204), the mapping in this step can also not work.

In some aspects, the EVSE visits that are mapped to the chargers by using the MAC address information or other mapping techniques described below are considered as “identified visits” or “identified EVSE visits” by the processor 114, shown by a block 220 in FIG. 2. Further, the EVSE visits that are not (or cannot be) mapped by using the MAC address information or other mapping techniques are treated as “unidentified visits” or “unidentified EVSE visits” by the processor 114, shown by a block 222 in FIG. 2. In some aspects, the processor 114 performs further mapping techniques or steps for the unidentified EVSE visits after the mapping step using the MAC address information, as described below.

The processor 114 attempts to map unidentified EVSE visits from the step described above by using timestamp information or charging start and stop times that are included in the vehicle information 204 and the charger information, shown by a block 224 in FIG. 2. As an example, if the charger information indicates a first timestamp associated with charging at the charger 110a, and the vehicle information 204 indicates a second timestamp associated with vehicle charging (e.g., successful vehicle charging or even unsuccessful charging attempts) during an EVSE visit, the processor 114 may compare the first timestamp and the second timestamp. The processor 114 may determine that the EVSE visit may be associated with the charger 110a or map the EVSE visit to the charger 110a, when the processor 114 determines that the first timestamp is equivalent to the second timestamp, based on the comparison.

It may be appreciated that a charge session should be recorded in both connected vehicle charging history (i.e., the vehicle information 204 or the vehicle charging information) and the dynamic charger history data (i.e., the charger information) with approximately the same charging start/end time. The processor 114 maps each charging session by checking the plug-in/plug-out timestamps in the vehicle information 204 and the charger information with a user-defined threshold, Δt (which may be adjusted by the system operator). A mapping outcome is expected for each charge session by using this timestamp approach. The processor 114 then aggregates the outcomes of each charging session to the EVSE visit, as described above.

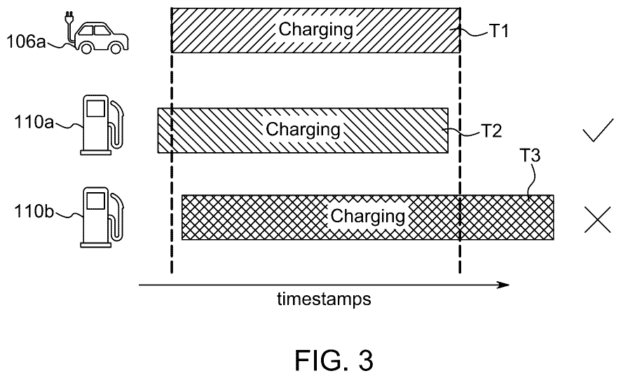

An example scenario of timestamp comparison is depicted in FIG. 3. As shown in FIG. 3, if a timestamp “T1” associated with the vehicle 106a for vehicle charging (included in the vehicle information 204) is substantially equivalent to a charging timestamp “T2” for the charger 110a but not equivalent to a charging timestamp “T3” for the charger 110b, the processor 114 may map the EVSE charging session or the EVSE visit (if it includes a single charging session) associated with the vehicle 106a to the charger 110a.

If the processor 114 is still not able to map all EVSE visits to chargers/EVSE by using the timestamp comparison technique described above (e.g., if two charger timestamps seem equivalent to a single vehicle timestamp, or if some vehicle or charger data is of suboptimal quality), the processor 114 may consider the unmapped EVSE visits as the unidentified visits 222.

Responsive to determining all the identified visits 220 and the unidentified visits 222 by using the steps/techniques described above, the processor 114 may merge back-to-back visits by a vehicle (e.g., by a single vehicle identifier as indicated in the vehicle information 204) to an EVSE, shown by a block 226 in FIG. 2.

It may be appreciated that a vehicle can have back-to-back EVSE visits charging at the same EVSE. This may happen because the processor 114 considers a slight vehicle movement (e.g., greater than 0.1 m) as a new EVSE visit, while the vehicle may still be charging at the same EVSE. For the vehicle user, these charge sessions from back-to-back visits by the same vehicle/VIN at the same EVSE belong to one charge experience. Hence, the processor 114 merges these visits. The processor 114 performs this merging step after the processor 114 has determined all the identified visits 220.

In some aspects, the processor 114 may identify back-to-back EVSE visits by the same VIN at the same EVSE when all back-to-back visits are consecutive visits by the same VIN without any other VIN in between, when all back-to-back visits are consecutive visits mapped to the same EVSE without any other EVSE in between, and when the vehicle movements between back-to-back visits is less than a threshold (e.g., less than 1 km), as tracked by the vehicle's odometer (and part of the vehicle information 204).

After performing this merging step (if any back-to-back EVSE visits are identified by using the criteria described above), the processor 114 may consider the lists of identified visits 220 and the unidentified visits 222 as final. Post this, the processor 114 may execute the instructions stored in the score estimation module 122 to estimate or calculate a charger reliability score (shown as “Scoring EVSE” block 228 in FIG. 2) for each charger 110 by correlating the charger information and the vehicle information 204 (or the vehicle charging information), as described below.

To score each EVSE, the processor 114 may first reset charging history by rolling MAC addresses (changes of MAC addresses to the same EVSE), shown by a block 230 in FIG. 2. Since a MAC address is tied to the charger's hardware (assuming it is not a randomized MAC address), rolling MAC addresses may indicate a hardware update performed to an EVSE, such as maintenance, replacement, etc. When the processor 114 identifies a rolling MAC address in the data structure described above (and shown as the block 208 in FIG. 2), the processor 114 may reset the reliability assessment by assuming an update is performed to the EVSE hardware. The processor 114 then excludes all charge visits prior to the most recent mapped MAC address from the scoring process described below.

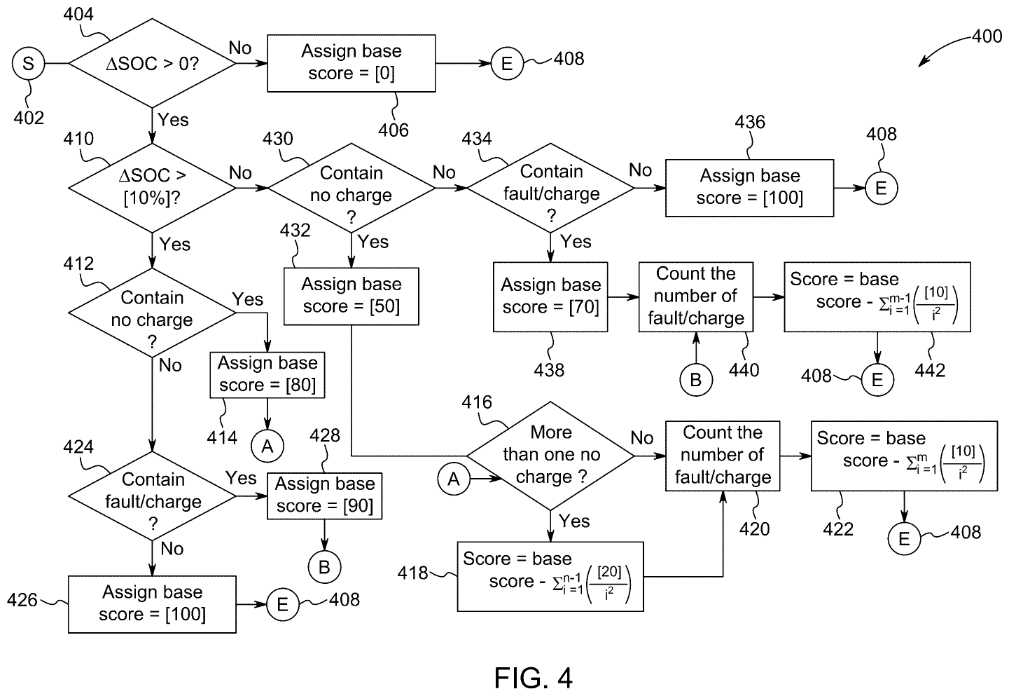

Responsive to performing the step described above, the processor 114 may score each EVSE visit, as shown by a block 232 in FIG. 2. In some aspects, the processor 114 may score each EVSE visit (or hence eventually calculate a reliability score for a charger/EVSE) based on a change in the vehicle's SOC during the EVSE visit, a count of one or more unsuccessful charging attempts at the charger/EVSE during the EVSE visit, a count of one or more charging faults experienced by the vehicle during the EVSE visit, and/or the like (which may be part of the vehicle information 204 or the vehicle charging information). An example process flow implemented by the processor 114 to score each EVSE visit is depicted in FIG. 4 and described below.

Prior to scoring, the processor 114 may label/mark/tag each charge session as “Charge” or “No Charge” based on whether the change in the vehicle's SOC during the charge session was greater than zero, and “Fault” or “No Fault” based on charging-related fault alerts that the vehicle 106 may have received during charging (that may be part of the vehicle information 204 or the vehicle charging information). Thereafter, the processor 114 may label/mark/tag each charge session as Fault/No Charge, Fault/Charged, No Fault/No Charge, or No Fault/Charged. After performing this labeling task, the processor 114 may group individual charge sessions to EVSE visits as described above. Thereafter, the processor 114 may determine, for the EVSE visit to be scored, a total count of “Fault/Charge” charge sessions as m, and a total count of “Fault/No Charge” and “No Fault/No Charge” charge sessions as n. Post this step, the processor 114 executes a process 400 depicted in FIG. 4

At step 402, the process 400 may start. At step 404, the processor 114 may determine whether the change in vehicle's SOC during the EVSE visit is greater than zero. If the change in vehicle's SOC during the EVSE visit is not greater than zero, then the processor 114 assigns a score of zero to the EVSE visit at step 406, and the process 400 ends at step 408.

On the other hand, if the change in vehicle's SOC is greater than zero, then at step 410, the processor 114 determines whether the change in vehicle's SOC is greater than a predefined SOC threshold (e.g., 10% or any other value set by the system operator). If the change in vehicle's SOC is greater than the predefined SOC threshold, then at step 412, the processor 114 determines whether the EVSE visit includes any “No charge” charge session. If such a charge session exists, the processor 114 may assign a base score of 80 to the EVSE visit at step 414. Thereafter, at step 416, the processor 114 may determine whether there are more than one “No charge” charge sessions in the EVSE visit. If more than one “No charge” charge sessions exist, the processor 114 may calculate the score as

$$Base Score - {\sum }_{i = 1}^{n - 1} ( \begin{matrix}[ 20 ] \\ {i}^{2}\end{matrix} ) ,$$

at step 418.

If more than one “No charge” charge sessions do not exist, then at step 420, the processor 114 may count a number of “Fault/Charge” charge sessions in the EVSE visit. The processor 114 may further calculate the score as

$$Base Score - {\sum }_{i = 1}^{m} ( \begin{matrix}[ 10 ] \\ {i}^{2}\end{matrix} ) ,$$

at step 422. The process 400 proceeds to the step 408 after the step 422.

If, at the step 412, the processor 114 determines that the EVSE visit does not include any “No charge” charge session, the processor 114 determines whether the EVSE visit includes any “Fault/Charge” charge sessions at step 424. If no, then at step 426, the processor 114 assigns a base score of 100 to the EVSE visit. Thereafter, the process 400 moves to the step 408.

On the other hand, if the processor 114 determines that the EVSE visit includes at least one “Fault/Charge” charge session at the step 424, the processor 114 assigns a base score of 90 to the EVSE visit, at step 428.

Further, if, at the step 410, the processor 114 determines that the change in vehicle's SOC is less than the predefined SOC threshold, the processor 114 determines whether the EVSE visit include a “No charge” charge session, at step 430. If yes, the processor 114 assigns a base score of 50 to the EVSE visit at step 432, and then the process 400 proceeds to the step 416 described above. On the other hand, if the processor 114 determines that the EVSE visit does not include any “No charge” charge session at the step 430, the processor 114 may determine whether a “Fault/Charge” charge session exists in the EVSE visit at step 434. If no, the processor 114 assigns a score of 100 to the EVSE visit at step 436, and then the process 400 proceeds to the step 408.

On the other hand, if the processor 114 determines that the EVSE visit includes at least one “Fault/Charge” charge session at the step 434, the processor 114 may assign a base score of 70 to the EVSE visit at step 438. At step 440, the processor 114 may determine a count of “Fault/Charge” charge sessions in the EVSE visit, and take input of the base score calculated at the step 428. Thereafter, at step 442, the processor 114 may calculate the score for the EVSE visit as

$$Base Score - {\sum }_{i = 1}^{m} ( \begin{matrix}[ 10 ] \\ {i}^{2}\end{matrix} ) ,$$

The process 400 proceeds to the step 408 after the step 442.

In this exemplary manner, the processor 114 may determine/calculate a score for each EVSE visit. Responsive to performing this step, the processor 114 may distribute scores of unidentified EVSE visits, as shown by a block 234 in FIG. 2. A person ordinarily skilled in the art may appreciate from the description above that an unidentified EVSE visit may be defined as an EVSE visit that may be indicated in the vehicle charging information but not indicated in the charger information, or indicated in the charger information but not indicated in the vehicle charging information. For example, if a vehicle charging timestamp or a MAC address included in the vehicle charging information is not available/included in the charger information (or vice-versa), the EVSE visit may be considered as an unidentified EVSE visit.

In some aspects, the processor 114 may first distribute the weight of the unidentified EVSE visits evenly to all EVSEs within the mapped charging station. In an exemplary aspect, the processor 114 may assign a weight (W_{j,id.}) of “1” to an identified EVSE visit and a weight W_{j,unid}. of “1/N” to an unidentified EVSE visit, where N is the count of EVSEs (e.g., the chargers 110) in the charging station 102.

It may be appreciated that the unidentified visits are mostly charging faults/unsuccessful charging attempts with zero (0) scores (which may be considered as scores for unidentified EVSE visits). By distributing the weight of unidentified visits evenly among EVSEs, the processor 114 penalizes or rewards the charging station 102 as a whole comparing to other charging stations, and does not change the reliability ranking/scores of EVSEs within the charging station 102.

Responsive to performing the step described above, the processor 114 may aggregate the scores from EVSE visits to EVSE, shown by a block 236 in FIG. 2. In some aspects, when aggregating EVSE visit scores to EVSE scores, the processor 114 may adjust the weights of EVSE visits calculated in the step described above, wⱼ, based on recency or the time of occurrence, such that the weights decay by event dates. In an exemplary aspect, the processor 114 may adjust the weights by using the mathematical expression illustrated below.

$${{w}_{j}^{⋆} = ( 1 - α ) )}^{Δ {D}_{j}} {w}_{j}$$

In this mathematical expression,

$${w}_{j}^{⋆}$$

is the adjusted weight, α between 0 and 1 is the decaying parameter, and ΔDⱼ is the charge recency in days (which is associated with the times of occurrence of both the identified and unidentified charging sessions/EVSE visits). Using the adjusted weights, the processor 114 may aggregate the EVSE reliability scores or EVSE scores by using exponentially weighted average (EWA), as illustrated below.

$${Score}_{EVSE} = \frac{{\sum }_{j ∈ EVSE} {w}_{j}^{⋆} \cdot {Score}_{j}}{{\sum }_{j ∈ EVSE} {w}_{j}^{⋆}} = \frac{{\sum }_{j ∈ EVSE} {( 1 − α )}^{Δ {D}_{j}} {w}_{j} \cdot {Score}_{j}}{{\sum }_{j ∈ EVSE} {( 1 − α )}^{Δ {D}_{j}} {w}_{j}}$$

Responsive to calculating the EVSE scores for the chargers 110 as described above, the processor 114 may transmit the calculated EVSE scores to one or more external devices, e.g., the user devices associated with a plurality of vehicle users and/or to the server 108 (and/or the computing devices associated with a plurality of other charging stations). The vehicle users may use the EVSE scores to make an informed decision of which chargers to use (e.g., a charger with a high reliability score) when the users arrive at the charging station 102. Furthermore, charging station operators may analyze the EVSE scores and plan repair, maintenance or replacement of one or more chargers based on the EVSE scores (e.g., for the chargers having low reliability scores).

In some aspects, responsive to calculating the EVSE scores as described above, the processor 114 may execute the instructions stored in the confidence determination module 124 to evaluate a confidence or estimate a confidence level associated with the calculated EVSE scores, shown by a block 238 in FIG. 2. It may be appreciated that the confidence level associated with the calculated EVSE scores may depend on data or information quantity and quality. In an exemplary aspect, the processor 114 may classify the confidence level into three categories, High, Medium, and Low. The processor 114 may determine or classify the confidence level based on a plurality of data parameters including, but not limited to, a recency of last visit or a time duration since a last charging event/EVSE visit at the charger/EVSE (as determined by the vehicle and charger information), a total count of charging events/EVSE visits associated with the charger/EVSE during the predefined time duration (e.g., the scoring window), a total count of unique vehicles/VINs charged at the charger/EVSE during the predefined time duration (or unique VINs per EVSE), a total count of unidentified charging events/EVSE visits or percentage of unidentified EVSE visits associated with the charger/EVSE, and/or the like.

In an exemplary aspect, after the processor 114 calculates/evaluates the confidence level for each of the four aspects described above, the processor 114 may calculate or determine the overall confidence level of the EVSE score as the minimum of the four confidence levels. In some aspects, along with the EVSE scores, the processor 114 may also transmit the overall confidence levels associated with the EVSE scores to the external devices described above.

In further aspects, the processor 114 may perform additional steps to enhance the EVSE scores by leveraging the charger information and Machine Learning (ML), shown by a block 240 in FIG. 2. It may be appreciated that not all EVSEs/chargers can be scored with Medium or High confidence level. In some aspects, some EVSEs cannot be scored at all by using the vehicle charging information, because there may be zero vehicle visits to those EVSEs in the vehicle information. The processor 114 overcomes this limitation by first determining those EVSEs/chargers that have EVSE scores with low confidence level, and then performing the steps described below to enhance the EVSE scores.

Broadly, the processor 114 performs the steps shown in FIG. 2 to enhance the EVSE scores. In an exemplary aspect, the processor 114 may first extract data of the identified EVSE visits 220 (shown as a block 242), and then train an ML model to score EVSE visits from charger information or charger history data (shown as a block 244). The processor 114 may then predict or estimate EVSE visit scores for all charger events (shown as a block 246), and aggregate EVSE visit scores using EWA (shown as a block 248). The processor 114 may then replace low confidence EVSE scores with updated scores (shown as a block 250). These steps are described below in detail.

It may be appreciated that the connected vehicle data (i.e., the vehicle information described above) includes more information than EVSE history data or charger information. For example, the vehicle information includes useful information that may assist in robustly calculating the EVSE scores including, but not limited to, ΔSoC to measure Charge/No Charge outcomes, Error logs to report Fault/No Fault outcomes, VIN, odometer, and vehicle GPS to define an EVSE visit, and/or the like. EVSE history data/charger information does not include any of the above information; it rather includes charger status in timestamps. Hence, using the charger history data alone cannot measure charging outcomes directly, nor could it replicate the method described above to calculate the EVSE score. The steps described below are just for enhancing the EVSE scores.

Though EVSE history data/charger information cannot be used to directly measure the charging outcomes, the processor 114 may still infer charging outcomes based on timestamps included in the EVSE history data/charger information. The logic behind this is that a user that incurred a “No Charge” charging session is unlikely to leave the charger plugged in for a long duration, and a user in need of charging is unlikely to use a public charger for a short period of time for 5-10 ΔSoC; hence the user is more likely to plug-in for a long time duration if the charge went through or if the user's vehicle was successfully charged.

Using the logic described above, the processor 114 may develop a classification model by using ML to estimate binary charging success/unsuccessful charging for each charge session as per the following expression.

$${\hat{Y}}_{charge success} = f ( time duration )$$

The processor 114 may train this classification model by using the information associated with the charge sessions in the identified EVSE visits 220 described above. In an exemplary aspect, this classification model can be solved by using machine learning methods such as logistic regression. Outcomes of this classification model can approximate Charge/No Charge outcomes in the prior scoring method. However, due to lack of error logs in the charger information, the processor 114 cannot approximate Fault/No Fault outcomes. In a test performed for the classification model, it was observed that the time duration threshold for a charging success or a successful charge is between 8 and 9 minutes.

Responsive to predicting the binary outcomes (i.e., Charge/No Charge outcomes) for each charge session, the processor 114 may assign scores of 0 or 100 for unsuccessful and successful charges. These scores may be considered as additional reliability scores (or additional scores) associated with unidentified charging sessions (or charging events if they include a single charging session).

After performing the step described above, the processor 114 may aggregate charge session scores (or the additional scores) to EVSE scores by using the similar EWA method as described above. In this case, in the mathematical expression illustrated below, i replaces j to represent each charge session (i.e., even those charging sessions that were not identified earlier using the process described above).

$${Score}_{EVSE} = \frac{{\sum }_{i ∈ EVSE} {w}_{i}^{⋆} \cdot {Score}_{i}}{{\sum }_{i ∈ EVSE} {w}_{i}^{⋆}} = \frac{{\sum }_{i ∈ EVSE} {( 1 − α )}^{Δ {D}_{j}} {w}_{i} \cdot {Score}_{i}}{{\sum }_{i ∈ EVSE} {( 1 − α )}^{Δ {D}_{i}} {w}_{i}}$$

In this manner, the processor 114 may calculate/estimate the final EVSE score or “updated” EVSE score for each EVSE based on the scores calculated by using the identified EVSE visits 220 and also the additional scores associated with the unidentified charging sessions as described above. Since the additional scores are based on the time durations associated with the charging attempts or charging sessions at the EVSE as described above, it may be appreciated that the final or updated EVSE score is based on the time durations described above (in addition to the EVSE score calculated based on the identified EVSE visits 220). As described above, the processor 114 may transmit the final/updated EVSE score to the external devices, so that the vehicle users may accordingly decide which charger to use for vehicle charging and/or the charging station operators may plan the charger maintenance/repair (e.g., for chargers will low EVSE scores).

It may be appreciated that although the additional scores are also scored between 0-100, these additional scores predicted from EVSE history data or charger information are expected to be different from the scores measured/estimated by using the vehicle charging information. Some sources of differences in this predicted score include, but are not limited to, binary scores inferred from charging duration, missing ΔSoC; and the scores scored by charging sessions, not by EVSE visits. The latter source results in a lower score, because by using the EVSE history data, the unsuccessful attempts are weighted the same, whereas the penalty for unsuccessful attempts diminishes when scoring by using the vehicle charging information. Another source of difference is that the EVSE history data overlooks pre-identification faults or unsuccessful charging attempts. This results in a higher score, because the EVSE history data does not have early-stage fault/unsuccessful charging records before the communication is established.

Therefore, it may be appreciated that scoring using the connected vehicle data is the preferred method for EVSE reliability scoring. Scoring by using the charger history data is a backup scoring method when the connected vehicle data for the designated EVSE is missing or sparse.

The vehicles 106 and the system 104 implement and/or perform operations, as described here in the present disclosure, in accordance with the owner manual and safety guidelines. In addition, any action taken by the vehicle users based on the notifications/recommendations/scores provided by the system 104 should comply with all the rules specific to the location and operation of the vehicles 106 (e.g., Federal, state, country, city, etc.). The notifications/recommendations/scores, as provided by the system 104, should be treated as suggestions and only followed according to any rules specific to the location and operation of the vehicles 106.

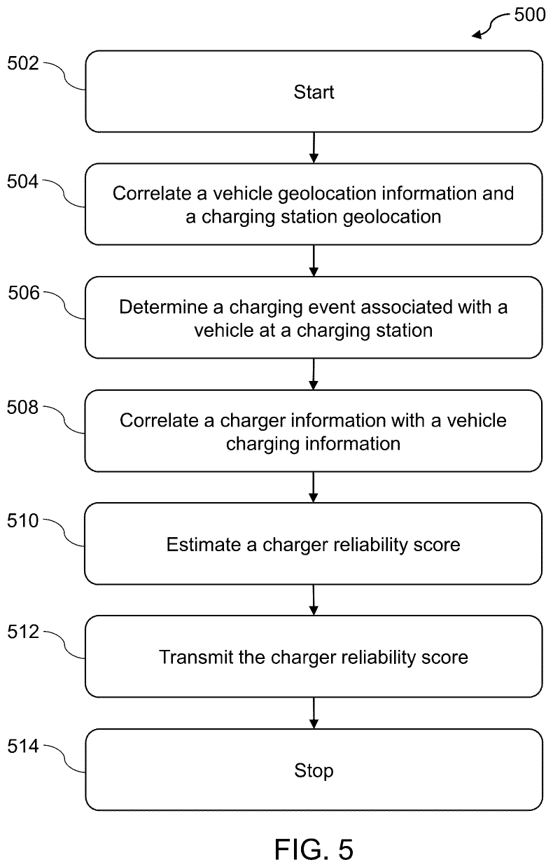

FIG. 5 depicts a flow diagram of an example second method 500 to estimate a charger reliability score in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include correlating, by the processor 114, the vehicle geolocation information and the charging station geolocation. At step 506, the method 500 may include determining, by the processor 114, a charging event or an EVSE visit associated with the vehicle 106 at the charging station 102 based on the correlation between the vehicle geolocation information and the charging station geolocation.

At step 508, the method 500 may include correlating, by the processor 114, the charger information with the vehicle charging information responsive to determining the charging event/EVSE visit. At step 510, the method 500 may include estimating, by the processor 114, a charger reliability score associated with the charger 110/EVSE based on the correlation between the charger information and the vehicle charging information. At step 512, the method 500 may include transmitting, by the processor 114, the charger reliability score to the external device(s) described above.

At step 514, the method 500 stops.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a transceiver configured to receive:
a vehicle information from a vehicle, wherein the vehicle information comprises a vehicle charging information and a vehicle geolocation information;
a charger information associated with a charger located at a charging station; and
a charging station geolocation; and
a processor configured to:
correlate the vehicle geolocation information and the charging station geolocation;
determine a charging event associated with the vehicle at the charging station based on the correlation between the vehicle geolocation information and the charging station geolocation;
correlate the charger information with the vehicle charging information, responsive to determining the charging event;
estimate a charger reliability score associated with the charger based on the correlation between the charger information and the vehicle charging information; and
transmit the charger reliability score to an external device.

2. The system of claim 1, wherein the charger is associated with a first media access control (MAC) address, wherein the transceiver is further configured to receive a data structure comprising a mapping between a plurality of chargers at the charging station and a plurality of MAC addresses, and wherein the vehicle charging information comprises a second MAC address associated with the charging event.

3. The system of claim 2, wherein the processor is further configured to:
correlate the second MAC address with the mapping;
identify, based on the correlation between the second MAC address and the mapping, that the charging event is associated with the charger when the second MAC address is equivalent to the first MAC address; and
estimate the charger reliability score associated with the charger responsive to determining that the charging event is associated with the charger.

4. The system of claim 1, wherein the charger information comprises a first timestamp associated with charging at the charger, and wherein the vehicle charging information comprises a second timestamp associated with successful vehicle charging during the charging event.

5. The system of claim 4, wherein the processor is further configured to:
compare the first timestamp with the second timestamp;
determine, based on the comparison, that the charging event is associated with the charger when the first timestamp is equivalent to the second timestamp; and
estimate the charger reliability score associated with the charger responsive to determining that the charging event is associated with the charger.

6. The system of claim 1, wherein the vehicle charging information further comprises an information associated with at least one of:
a change in state of charge (SOC) of the vehicle during the charging event,
one or more unsuccessful charging attempts at the charger during the charging event, or
one or more charging faults detected by the vehicle during the charging event.

7. The system of claim 6, wherein the processor is configured to estimate the charger reliability score based on at least one of:
the one or more charging faults,
the one or more unsuccessful charging attempts, or
the change in SOC.

8. The system of claim 1, wherein the processor is further configured to:
determine one or more unidentified charging events indicated in the vehicle charging information and not indicated in the charger information, or indicated in the charger information and not indicated in the vehicle charging information;
determine one or more additional reliability scores associated with the one or more unidentified charging events; and
estimate the charger reliability score based on the one or more additional reliability scores and a total count of chargers at the charging station.

9. The system of claim 8, wherein the processor is further configured to estimate the charger reliability score based on times of occurrence of the charging event and the one or more unidentified charging events.

10. The system of claim 8, wherein the processor is further configured to estimate a confidence level associated with the charger reliability score based on at least one of:
a time duration since a last charging event at the charger,
a total count of charging events associated with the charger during a predefined time duration,
a total count of unique vehicles charged at the charger during the predefined time duration, or
a total count of unidentified charging events associated with the charger.

11. The system of claim 10, wherein the processor is further configured to transmit the confidence level to the external device.

12. The system of claim 10, wherein the processor is further configured to:
determine that the confidence level is less than a predefined threshold;
determine a plurality of time durations associated with historical charging attempts at the charger based on the charger information, responsive to determining that the confidence level is less than the predefined threshold;
estimate an updated charger reliability score based on the plurality of time durations; and
transmit the updated charger reliability score to the external device.

13. The system of claim 1, wherein the external device is a server or a user device.

14. A method comprising:
correlating, by a processor, a vehicle geolocation information and a charging station geolocation;
determining, by the processor, a charging event associated with a vehicle at a charging station based on the correlation between the vehicle geolocation information and the charging station geolocation;
correlating, by the processor, a charger information with a vehicle charging information responsive to determining the charging event, wherein the charger information is associated with a charger located at the charging station;
estimating, by the processor, a charger reliability score associated with the charger based on the correlation between the charger information and the vehicle charging information; and
transmitting, by the processor, the charger reliability score to an external device.

15. The method of claim 14, wherein the charger is associated with a first media access control (MAC) address, and wherein the vehicle charging information comprises a second MAC address associated with the charging event.

16. The method of claim 15 further comprising:
correlating the second MAC address with a mapping between a plurality of chargers at the charging station and a plurality of MAC addresses;
identifying, based on the correlation between the second MAC address and the mapping, that the charging event is associated with the charger when the second MAC address is equivalent to the first MAC address; and
estimating the charger reliability score associated with the charger responsive to determining that the charging event is associated with the charger.

17. The method of claim 14, wherein the charger information comprises a first timestamp associated with charging at the charger, and wherein the vehicle charging information comprises a second timestamp associated with successful vehicle charging during the charging event.

18. The method of claim 17 further comprising:
comparing the first timestamp with the second timestamp;
determining, based on the comparison, that the charging event is associated with the charger when the first timestamp is equivalent to the second timestamp; and
estimating the charger reliability score associated with the charger responsive to determining that the charging event is associated with the charger.

19. The method of claim 14, wherein the external device is a server or a user device.

20. A non-transitory computer-readable storage medium having instructions stored thereupon which, when executed by a processor, cause the processor to:
correlate a vehicle geolocation information and a charging station geolocation;
determine a charging event associated with a vehicle at a charging station based on the correlation between the vehicle geolocation information and the charging station geolocation;
correlate a charger information with a vehicle charging information responsive to determining the charging event, wherein the charger information is associated with a charger located at the charging station;
estimate a charger reliability score associated with the charger based on the correlation between the charger information and the vehicle charging information; and
transmit the charger reliability score to an external device.
